(19) United States
(12) Patent Application Publication
(10) Pub. No.: US 2018/0356068 A1
(43) Pub. Date: Dec. 13, 2018

(54) REFLECTIVE LIGHT-EMITTING APPARATUS

(71) Applicant: OPTO TECH CORPORATION, HSINCHU COUNTY (TW)

(72) Inventors: CHIEN-FENG CHANG, HSINCHU (TW); TSUNG-HUAI LEE, HSINCHU (TW); YING-CHIEH PENG, HSINCHU (TW); WEI-CHIH LIN, HSINCHU (TW)

(21) Appl. No.: 15/618,521

(22) Filed: Jun. 9, 2017

(51) Int. Cl. F21V 7/00

(52) U.S. Cl. CPC F21V 7/0008; G02F 1/167; F21V 7/0083

(57) ABSTRACT

A reflective light-emitting apparatus is provided. The apparatus comprises one or more substrate structure, one or more base, and one or more reflective structure. The substrate structure is disposed in an accommodating space of the base. A light-emitting unit of the substrate structure emits light to the reflective structure. A first reflection surface and a second reflection surface of the reflective structure produce first reflection light and second reflection light according to the light emitted from the light-emitting unit in different reflection angles. Moreover, the substrate structure, the base, and the reflection structure of the reflective light-emitting apparatus according to the present invention can be plural. Besides, the base and the reflection structure are interlaced.

### FIELD OF THE INVENTION

The present invention relates generally to a light-emitting apparatus, and particularly to a reflective light-emitting apparatus.

### BACKGROUND OF THE INVENTION

Generally, light-emitting devices, such as LEDs, are point light sources. For the development of the plane light sources, if the light-emitting device owns high brightness, the light-emitting intensity at the central part will be stronger, which makes a plane light source nonunifrom. Even fluorescent powders are adopted for converting light or secondary optics are applied for adjustment, as viewed from the outside of a light-emitting apparatus, the photochrome at the central part is stronger than the surrounding part. Thereby, in general, to enable uniform light emission from assembled light-emitting devices, light guide plates are adopted as the media for uniform lighting. Nonetheless, as the light-emitting area becomes larger, the deviation in brightness becomes more obvious. Accordingly, large advertisement information boards such as signboard or outdoor billboards use a plurality of point light sources arranged to project and become a light source.

In addition, in the past, the light sources used by advertisement information boards include halogen or discharge lamps. For example, as shown in FIG. 1, a light-emitting apparatus 101 is disposed at the front bottom side of the signboard 100. By using the light emitted by the light-emitting apparatus 101, the illuminated plane (the surface) of the signboard 100 is illuminated and forming an external lighting apparatus 103. The light-emitting apparatus 101 is used in the external lighting apparatus 103. The light-emitting apparatus 101 uses the reflection part 106 installed inside the housing 105 to reflect the light from the light source 104. The light from the light source 104 and reflected by the reflection part 106 is then refracted by the lens 107 and emitted. By using the lens 107, the light from the light source 104 and reflected by the reflection part 106 is projected to the illuminated plane 102. This method is applied to advertisement information, such as election information, house information, or cultural activities.

Nonetheless, for current lighting apparatuses, the structure of the light-emitting apparatus is complicated and the number of components is massive, leading to repeated increases in the price due to the raised material costs. In addition, the structure can no longer meet the requirement of saving space. Because halogen or discharge lamps are adopted as the lighting apparatus, compared with LEDs, the power consumption of the former is much greater than the latter. Thereby, traditional lighting apparatuses cannot satisfy the power-saving requirement.

To solve the above problems, the present invention provides a reflective light-emitting apparatus, which avoids complicated structure and reduces the occupied space. Besides, the lighting area of the light-emitting apparatus can be adjusted according to requirements.

### SUMMARY

An objective of the present invention is to provide a reflective light-emitting apparatus.

The present invention provides a reflective light-emitting apparatus, which comprises a substrate structure, a base, and a reflective structure. The base includes a light-emitting unit. The base includes an accommodating space and a light-emitting opening on a side. The light-emitting opening communicates with the accommodating space. The substrate structure is disposed in the accommodating space. The light-emitting unit emits light through the light-emitting opening. The reflective structure is connected with the base and includes a first reflection surface and a second reflection surface, which produce first reflection light and second reflection light according to the light emitted from the light-emitting unit. The reflection angles of the first and second reflection light are different. The first reflection surface is adjacent to the light-emitting opening.

According to an embodiment of the present invention, the reflective light-emitting apparatus further comprises a flexible display panel disposed on the first and second reflection surfaces. Different visible light can be scattered from the first and second reflection light according to the flexible display panel.

According to an embodiment of the present invention, a second tilt angle of the second reflection surface of the reflective light-emitting apparatus is greater than a first tilt angle of the first reflection surface.

According to an embodiment of the present invention, the light-emitting unit of the reflective light-emitting apparatus dissipates heat to the base via the substrate structure.

According to an embodiment of the present invention, the light-emitting unit of the reflective light-emitting apparatus includes one or more LED.

The present invention further provides a reflective light-emitting apparatus, which comprises a plurality of substrate structures, a plurality of bases, and a plurality of reflective structures. The plurality of bases include one or more light-emitting unit. The plurality of bases include an accommodating space, respectively, and a light-emitting opening on a side, respectively. The light-emitting opening communicates with the accommodating space. The plurality of substrate structures are disposed in the plurality of accommodating spaces of the plurality of bases, respectively. The plurality of light-emitting units of the plurality of bases emit light through the plurality of light-emitting openings of the plurality of bases. The plurality of reflective structures are disposed on one side of the plurality of bases and include a first reflection surface and a second reflection surface, respectively. The plurality of first reflection surfaces and the plurality of second reflection surfaces of the plurality of reflective structures produce first reflection light and second reflection light according to the light emitted from the plurality of light-emitting units of the plurality of bases, respectively. The reflection angles of the first reflection light of the plurality of first reflection surfaces and the reflection angles of the second reflection light of the plurality of second reflection surfaces are different. The plurality of reflection structures and the plurality of bases are arranged in order.

According to an embodiment of the present invention, the reflective light-emitting apparatus further comprises a plurality of flexible display panels disposed on the plurality of first reflection surfaces and the plurality of second reflection surfaces, respectively. Different visible light can be scattered from the first and second reflection light according to the plurality of flexible display panels.

According to an embodiment of the present invention, the second reflection surface of the final reflection structure in the plurality of reflection structures is not connected to any other structure, while the plurality of second reflection surfaces of the plurality of the rest reflection structures are connected to a top surface of the next base.

According to an embodiment of the present invention, the plurality of light-emitting units of the light-emitting apparatus dissipate heat to the plurality of bases via the plurality of bases.

According to an embodiment of the present invention, the plurality of the light-emitting units of the reflective light-emitting apparatus include one or more LED, respectively.

By using the technical method according to the present invention, the base accommodates the substrate structure disposed with the light-emitting unit. The light-emitting unit illuminates the reflective structure through the light-emitting opening of the base, so that the disposition of the whole light-emitting apparatus is more simplified and the space can be fully utilized according to requirements. Preferably, the reflective light-emitting apparatus meets the requirements via the combination of the base and the reflective structure and thus reducing the usage space.

### BRIEF DESCRIPTION OF THE DRAWINGS

FIG. 1 shows a structural schematic diagram of the signboard structure according to an embodiment of the prior art;

FIG. 2 shows a structural schematic diagram of the reflective light-emitting apparatus according to an embodiment of the present invention;

FIG. 3A shows an enlarged structural schematic diagram of the reflective light-emitting apparatus according to an embodiment of the present invention;

FIG. 3B shows a schematic diagram of the reflection light of the reflective light-emitting apparatus according to an embodiment of the present invention;

FIG. 4 shows a structural schematic diagram of the reflective light-emitting apparatus according to an embodiment of the present invention;

FIG. 5 shows a structural schematic diagram of the reflective light-emitting apparatus according to an embodiment of the present invention;

FIG. 6 shows a structural schematic diagram of the reflective light-emitting apparatus according to another embodiment of the present invention; and

FIG. 7 shows an enlarged structural schematic diagram of the reflective light-emitting apparatus according to another embodiment of the present invention.

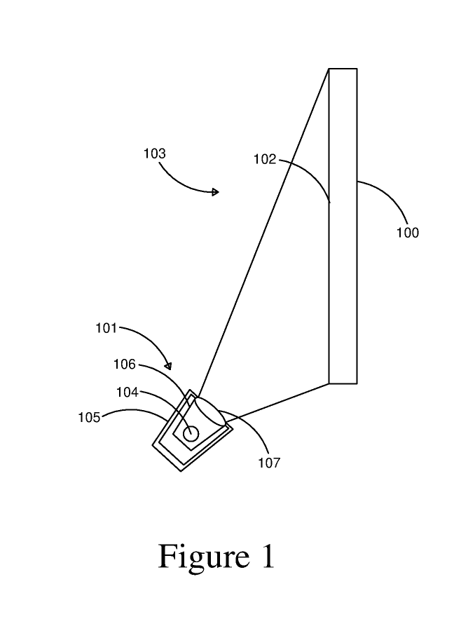

### DETAILED DESCRIPTION

In order to make the structure and characteristics as well as the effectiveness of the present invention to be further understood and recognized, the detailed description of the present invention is provided as follows along with embodiments and accompanying figures.

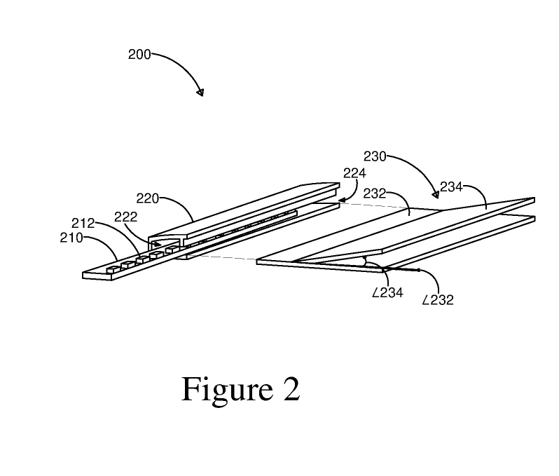

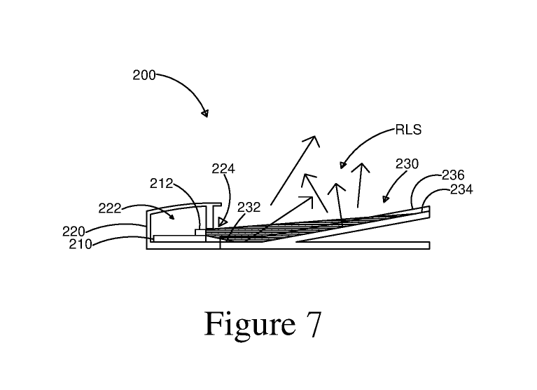

In the following, according to FIG. 2 to FIG. 7, the embodiments of the present invention will be described. Nonetheless, instead of limiting the embodiments, the description is only an embodiment of the present invention.

As shown in FIG. 2, a reflective light-emitting apparatus 200 according to an embodiment of the present invention comprises a substrate structure 210, a base 220, and a reflective structure 230. The substrate structure 210 includes one or more light-emitting unit 212. Preferably, the present embodiment adopts a plurality of light-emitting units 212 arranged in a line. The base 220 includes an accommodating space 222. In addition, a light-emitting opening 224 is disposed on one side of the base 220. The reflective structure 230 includes a first reflection surface 232 and a second reflection surface 234.

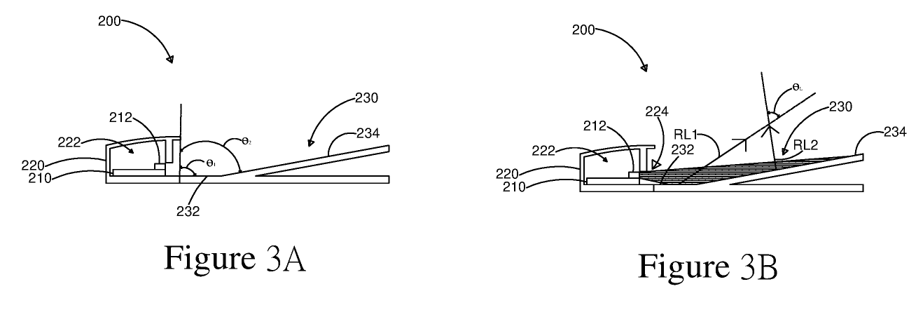

According to the present embodiment, the substrate structure 201 includes a plurality of light-emitting units 212, such as a plurality of LEDs, for giving a preferred light-emitting area. Nonetheless, the present invention is not limited to the disposition according to the present embodiment. Alternatively, a single light-emitting unit 212 can be adopted for focusing on a single lighting region. The light-emitting units 212 are disposed on the substrate structure 210 and arranged in a line. In addition, one side of the light-emitting units 212 face the light-emitting opening 224 of the base 220; the light-emitting opening 224 is adjacent to the first reflection surface 232 of the reflection structure 230. Thereby, the light-emitting units 212 illuminate the first and second reflection surfaces 232, 234 of the reflection structure 230 through the light-emitting opening 224 of the base 220, and a side of the first reflection surface 232 extending to dispose a side of the second surface 234. As shown in FIG. 3A, the base 220 and the reflection structure 230 are disposed horizontally and connected to each other. Thereby, a first angle θ₁ is formed between the first reflection surface 232 and the base 220; a second angle θ₂ is formed between the second reflection surface 234 and the base 220.

As shown in FIG. 3B, the first reflection light RL1 and the second reflection light RL2 are produced from the first and second reflection surfaces 232, 234, respectively, according the light emitted from the light-emitting units 212. In addition, due to the difference between the first angle θ₁ and the second angle θ₂, the first reflection light RL1 and the second reflection light RL2 exhibit different reflection angles and hence forming a reflection-light angle θ_{L}. In other words, when people see the reflection structure 230, they can see the first reflection light RL1 and the second reflection light RL2 at different viewing angles. Besides, the base 220 and the reflection structure 230 according to the present embodiment are made of aluminum through aluminum extrusion process. Thereby, the light-emitting units 212 can further dissipate heat to the base 220 via the substrate structure 210 and the heat will be led outward from the base 220. Moreover, by adopting smaller light-emitting units 212, such as LEDs, the base 220 can be made smaller and thus saving space.

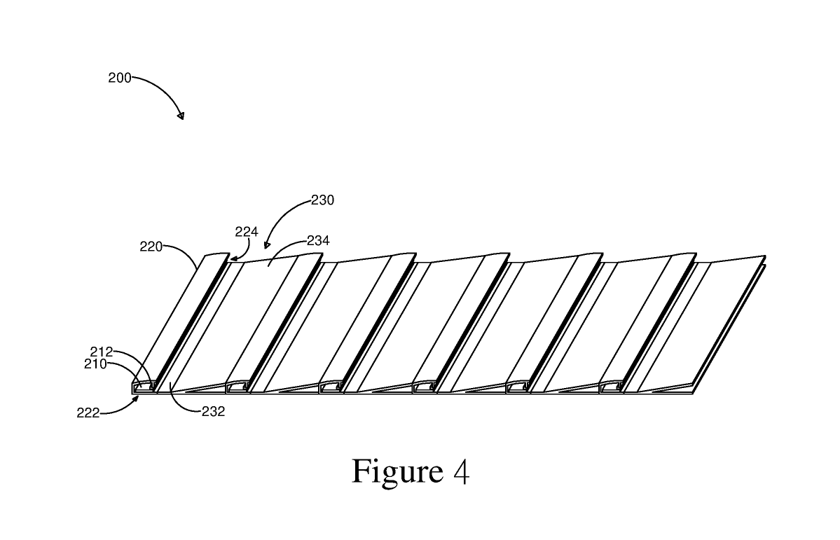

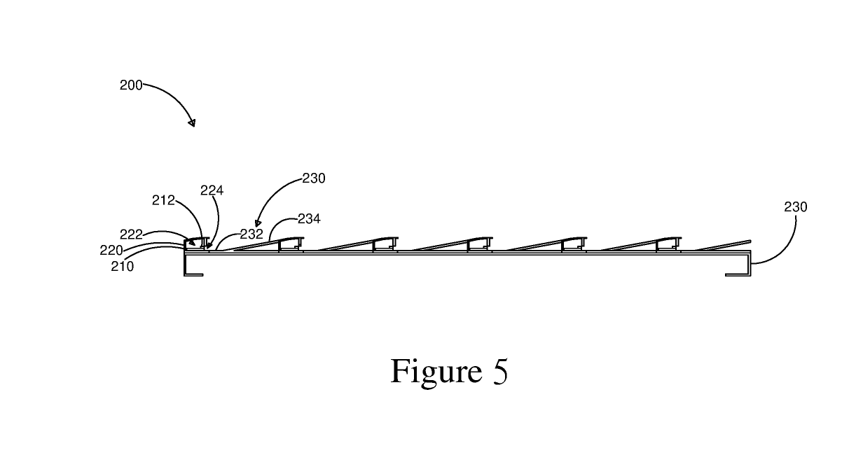

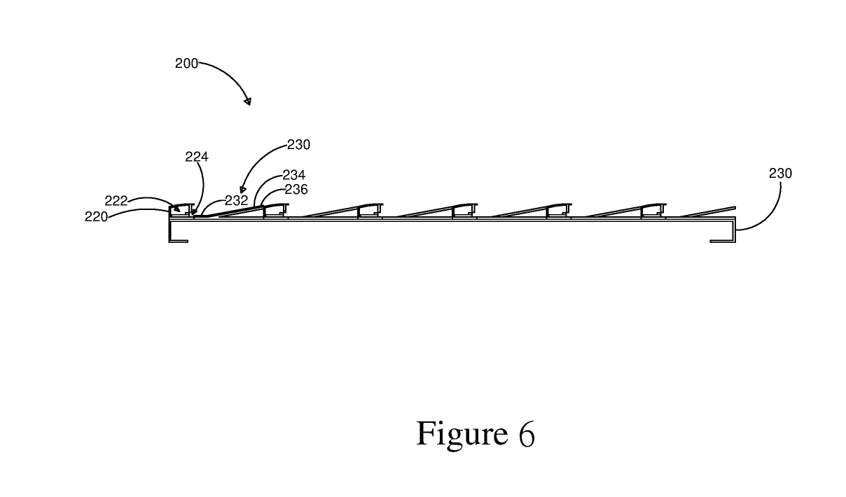

As shown in FIG. 4 and FIG. 5, the reflective light-emitting apparatus 20 according to the present invention adopts an arrangement including plural components. A plurality of substrate structures 210 are disposed on a plurality of bases 220. The plurality of bases 220 are adjacent and connected to the plurality of reflective structures 230. That is to say, the plurality of bases 220 and the plurality of reflective structures 230 are interlaced in order. Thereby, the reflective light-emitting apparatus 200 according to the present invention can be further applied to large-area lighting applications such as outdoor large billboards and outdoor signboards. In addition, as shown in FIG. 6, according to the present invention, a flexible display panel 236 can be further disposed on the first and second reflection surfaces 232, 234 of the reflective structure 230. By using the flexible display panel 236, the reflection light from the first and second reflection surfaces 232, 234 is not limited to the first and second reflection light RL1, RL2. Instead, by using the pattern displayed on the flexible display panel 236, the scattered light RLS is formed. Namely, the light emitted from the light-emitting units 212 can give the desired pattern and effect of the scattered visible light according to the flexible display panel 236. The flexible display panel 236 according to the present embodiment can be a display device such as an e-paper or an OLED.

To sum up, the reflective light-emitting apparatus according to the present invention can save size by adopting light-emitting units with smaller volume. In addition, by the using the aluminum-extrusion base, the light-emitting structure is simplified. Moreover, good heat dissipation can be achieved with ease via the base.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A reflective light-emitting apparatus, comprising:
a substrate structure, having a light-emitting unit;
a base, including an accommodating space, having a light-emitting opening on one side of said base, said light-emitting opening connecting to said accommodating space, said substrate structure disposed in said accommodating space, said light-emitting unit emitting a light through said light-emitting opening; and
a reflective structure, connected to said base, having a first reflection surface and a second reflection surface reflecting a first reflection light and a second reflection light according to the light from said light-emitting unit, a side of the first reflection surface extending to dispose a side of the second reflection surface, said first reflection light and said second reflection light having different reflection angles, and said first reflection surface adjacent to said light-emitting opening.

2. The reflective light-emitting apparatus of claim 1, further comprising a flexible display panel, disposed on said first reflection surface or said second reflection surface.

3. The reflective light-emitting apparatus of claim 2, wherein a second tilt angle of said second reflection surface is greater than a first tile angle of said first reflection surface.

4. The reflective light-emitting apparatus of claim 1, wherein said base and said reflective structure are disposed horizontally; a first angle is formed between said first reflection surface and said base; a second angle is formed between said second reflection surface and said base; and said first angle and said second angle make the reflection angles of said first reflection light and said second reflection light different.

5. The reflective light-emitting apparatus of claim 1, wherein said light-emitting unit dissipates heat to said base via said substrate structure.

6. The reflective light-emitting apparatus of claim 1, wherein said light-emitting unit is at least one light-emitting diode.

7. A reflective light-emitting apparatus, comprising:
a plurality of substrate structures, including one or more light-emitting unit, respectively;
a plurality of bases, including an accommodating space, respectively, having a light-emitting opening on one side of each of said bases, respectively, said light-emitting opening connecting with said accommodating space, said plurality of substrate structures disposed in said plurality of accommodating spaces of said plurality of bases, respectively, said plurality of light-emitting units of said plurality of substrate structures emitting light through said plurality of light-emitting openings of said plurality of bases, respectively; and
a plurality of reflective structures, disposed on one side of said plurality of bases, respectively, having a first reflection surface and a second reflection surface, respectively, said plurality of first reflection surfaces and said plurality of second reflection surfaces of said plurality of reflection structures producing first reflection light and second reflection light according to the light emitted from said plurality of light-emitting units of said plurality of substrate structures, respectively, said first reflection light of said plurality of first reflection surfaces and said second reflection light of said plurality of second reflection surfaces having different reflection angles, respectively, a side of the first reflection surface extending to dispose a side of the second surface, said plurality of first reflection surfaces adjacent to said plurality of light-emitting openings of said plurality of bases, respectively, and said plurality of reflective structures and said plurality of bases interlaced in order.

8. The reflective light-emitting apparatus of claim 7, further comprising a plurality of flexible display panels, disposed on said plurality of first reflection surfaces or said plurality of second reflection surfaces of said plurality of reflective structures, respectively.

9. The reflective light-emitting apparatus of claim 7, wherein said second reflective surface of the final reflective structure of said plurality of reflective structures is connected to the structure and said plurality of second reflective surfaces of said plurality of rest reflective structures is connected to a top surface of the next base.

10. The reflective light-emitting apparatus of claim 7, wherein said base and said reflective structure are disposed horizontally; a first angle is formed between said first reflection surface and said base; a second angle is formed between said second reflection surface and said base; and said first angle and said second angle make the reflection angles of said first reflection light and said second reflection light different.

11. The reflective light-emitting apparatus of claim 7, wherein said plurality of light-emitting units dissipate heat to said plurality of bases via said plurality of substrate structures.

12. The reflective light-emitting apparatus of claim 7, wherein said plurality of light-emitting units comprise individually at least one light-emitting diode.
